(19) United States
(12) Patent Application Publication
(10) Pub. No.: US 2011/0153644 A1
(43) Pub. Date: Jun. 23, 2011

(54) METHOD AND APPARATUS FOR UTILIZING A SCALABLE DATA STRUCTURE

(75) Inventors: Yekesa Kosuru, Westford, MA (US); Jari Karjala, Vantaa (FI); Matti Oikarinen, Oulu (FI)

(73) Assignee: Nokia Corporation, Espoo (FI)

(21) Appl. No.: 12/645,115

(22) Filed: Dec. 22, 2009

(51) Int. Cl. G06F 17/30

(52) U.S. Cl. 707/769; 707/783; 707/E17.014

(57) ABSTRACT

An approach is provided for utilizing a scalable data structure. A query specifying an entity identifier and requested content is received. A search is caused, at least in part, the search based on the entity identifier of a profile index of data structures, each specifying a profile field that is associated with an access control field to yield a search result. Access rights to the requested content are indicated for the entity identifier. The data structures further include the profile field and the access control field.

### BACKGROUND

Service providers (e.g., wireless, cellular, etc.) and device manufacturers are continually challenged to deliver value and convenience to consumers by, for example, providing compelling network services. Important differentiators in the industry are application and network services as well as capabilities to support and scale these services. In particular, these applications and services can include accessing and managing data utilized, for example, by social services. These services entail managing a tremendous amount of user profiles relating to data access. Traditionally, separate mechanisms exist for controlling access and the manner in which data is organized. As the number of users grow, these mechanisms do not scale well, and can result in greater and greater delay with respect to information retrieval.

### SOME EXAMPLE EMBODIMENTS

Therefore, there is a need for an approach for utilizing a scalable data structure to search profiles (e.g., user profiles, entity profiles, etc.).

According to one embodiment, a method comprises receiving a query specifying an entity identifier and requested content. The method also comprises causing, at least in part, a search based on the entity identifier of a profile index of data structures, each specifying a profile field that is associated with an access control field to yield a search result. The method further comprises indicating access rights to the requested content for the entity identifier. The data structures further include the profile field and the access control field.

According to another embodiment, an apparatus comprising at least one processor, and at least one memory including computer program code, the at least one memory and the computer program code configured to, with the at least one processor, cause, at least in part, the apparatus to receive a query specifying an entity identifier and requested content. The apparatus is also caused to cause, at least in part, a search based on the entity identifier of a profile index of data structures, each specifying a profile field that is associated with an access control field to yield a search result. The apparatus is further caused to indicate access rights to the requested content for the entity identifier. The data structures further include the profile field and the access control field.

According to another embodiment, a computer-readable storage medium carrying one or more sequences of one or more instructions which, when executed by one or more processors, cause, at least in part, an apparatus to receive a query specifying an entity identifier and requested content. The apparatus is also caused to cause, at least in part, a search based on the entity identifier of a profile index of data structures, each specifying a profile field that is associated with an access control field to yield a search result. The apparatus is further caused to indicate access rights to the requested content for the entity identifier. The data structures further include the profile field and the access control field.

According to another embodiment, an apparatus comprises means for receiving a query specifying an entity identifier and requested content. The apparatus also comprises means for causing, at least in part, a search based on the entity identifier of a profile index of data structures, each specifying a profile field that is associated with an access control field to yield a search result. The apparatus further comprises means for indicating access rights to the requested content for the entity identifier. The data structures further include the profile field and the access control field.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of utilizing a scalable data structure, according to one embodiment;

FIG. 1B is a diagram of the components of a distributed index engine, according to one embodiment;

FIG. 1C is a diagram of the components of a distributed key value store, according to one embodiment;

FIG. 2 is a diagram exemplifying the use of a scalable data structure, according to one embodiment;

FIG. 3 is a diagram of an exemplary data structure that may be utilized in the distributed key value store, according to one embodiment;

FIG. 4 is a flowchart of a process for creating and indexing a profile, according to one embodiment;

FIG. 5 is a flowchart of a process for utilizing a scalable data structure to search profiles, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for utilizing a scalable data structure to search user profiles are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

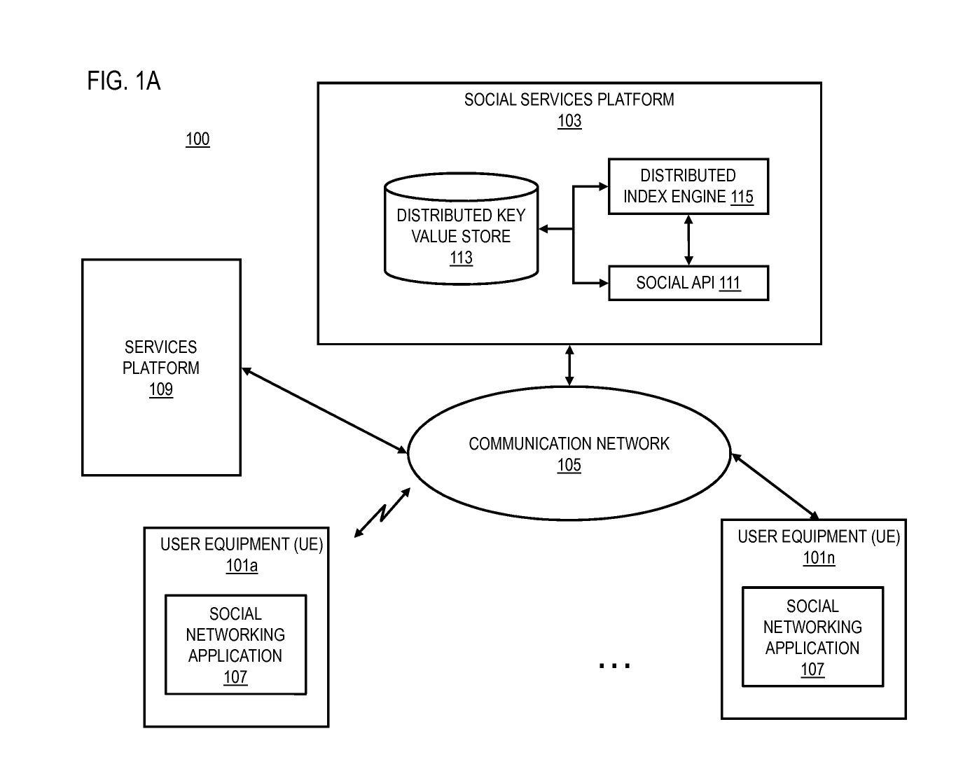

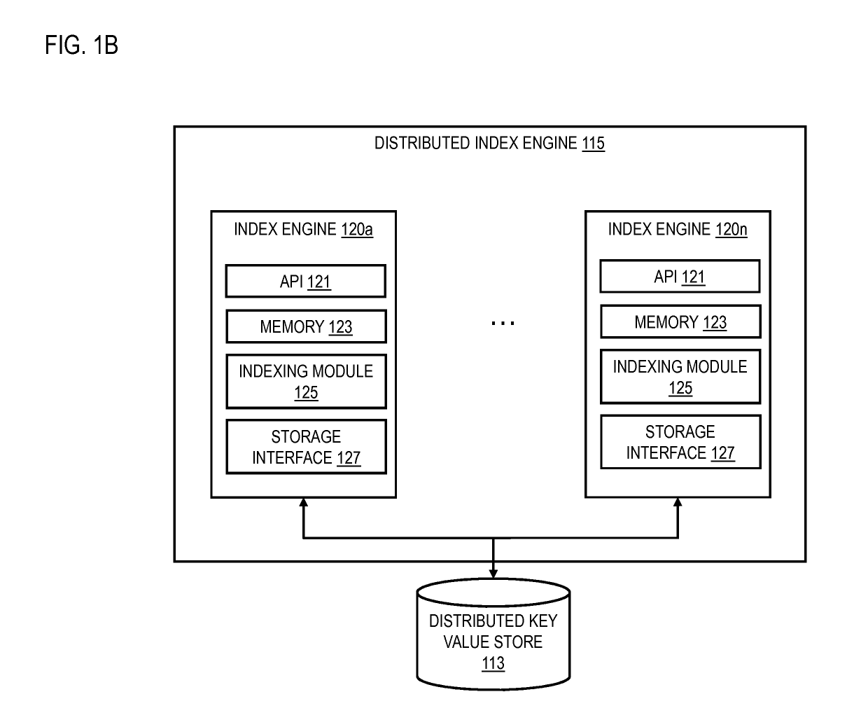

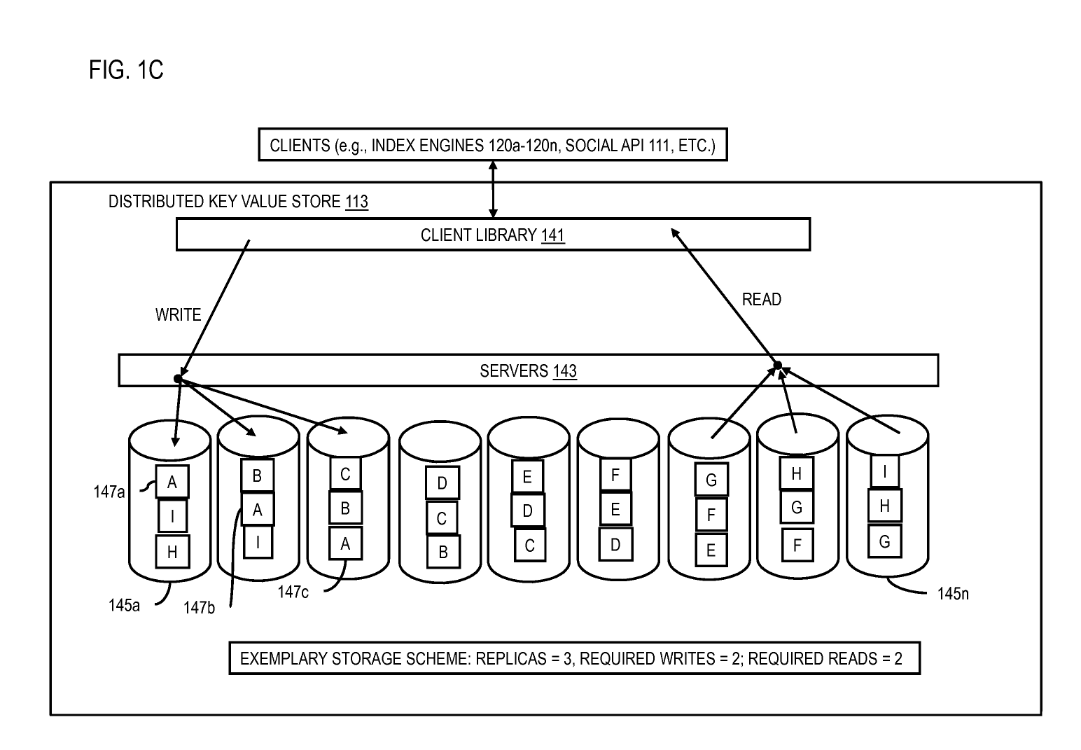

FIG. 1A is a diagram of a system capable of utilizing a scalable data structure, according to one embodiment. With the increasing demand for network services (in particular social networking services), the need to properly manage the access of user contact data, profile data, and connections data of the users, for example, is of paramount concern. An integral part of social network services is the continual searches and update of these data. Consequently, these search and retrieval functions have led to larger and larger databases. It is noted that the size, efficiency, and latency of the databases may be limited based on how the data is stored.

To address this problem, a system 100 of FIG. 1 introduces the capability to utilizing a scalable data structure. The data structure may store information about one or more entities, such as persons, companies, organizations, groups, etc. In certain embodiments, the data structure may include an access control field, a profile identifier, one or more fields associated with profile data (e.g., contact information such as address data, email data, phone number data, etc., name data, other identifiers, friend data, other data associated with profiles such as comment data, other data about the entity, etc.), or a combination thereof. Moreover, other data may be utilized. The access control field, for instance, can be associated with one or more entity identifiers or other identifiers signifying that the identifier has access to the profile identifier and the one or more associated fields. In certain embodiments, an entity identifier is an identifier that is associated with a user, a group, an organization, etc. Although various embodiments are described with respect to user identifiers, it is contemplated that the approach described herein may be used with other entity identifiers including group identifiers, organization identifiers, member identifiers, employee identifiers, etc. Further, entities or users belonging to entities may authenticate with the system 100 by providing the entity identifier or another identifier that is linked to the entity identifier. In other words, a user identifier may be linked to multiple entity identifiers (e.g., an employer identifier, a group identifier, etc.) associated with the user of the user identifier. Under one scenario, users can utilize a service using their user equipment (UE) 101a-101n, which interact with a social services platform 103 over a communication network 105. Each of the UEs 101a-101n may use one or more applications 107 to utilize the social services platform 103 to retrieve information about entities using the data structure.

Further, in one embodiment, the access control field of the data structure may be indexed using a version of text indexing. In text indexing, a variable (e.g., a document or a profile) may be indexed based on each word contained within the variable that is true. For example, the string variable “this is the first version, not the beta version” includes the words “this,” “is,” “the,” “first,” “version,” “not,” and “beta.” It also includes some words multiple times as well as certain common words. In one scenario, the access control field may be indexed where each word is a user identifier or entity identifier. Moreover, the data structure may be used to create an inverted index. An inverted index is an index data structure that can store a mapping from content (e.g., words or numbers stored with a user profile) to its locations in a database file, a document, a set of documents, etc. In certain scenarios, for each entity identifier, there are a number of lines that define different visibilities to locations of data associated with a profile of a user or entity. Additionally, other indexes may be utilized (e.g., hash table data structure or tree data structures such as the B-tree index) in place of or in addition to the inverted index for indexing the data structure. A B-tree is a tree data structure similar to a binary search tree, but with the capability of having more than one paths diverging from a node. The B-tree index may include a first record of a segment of a database. As such, the B-tree index can be used to determine which segment of the database of data structures to search. Hash tables may additionally be utilized to map identifiers or keys (e.g., names) to values (e.g., a number). Then, the values can be indexed using the hash to search for the keys. Further exemplary implementation details of hash indexing are discussed in FIG. 1C.

Further, a services platform 109 may routinely interact with the social services platform 103. The services platform 109 may provide social services, messaging services, insurance services, retail services, music services, or other like services that may utilize data stored in the social services platform 103. For example, some of the services may access the social services platform 103 to access profile data of one or more users and provide that information to one or more users of the services platform 109 utilizing applications 107 on their respective UEs 101. Moreover, one or more services of the services platform 109 may be entities with profile information stored using the social services platform 103.

A service or a user, utilizing a social networking application 107, may create, manage, update, search, or retrieve a profile by sending a request to the social services platform 103. The social services platform 103 may utilize a social application programming interface (API) 111 to receive the request. In certain embodiments, the social API 111 may be implemented on one or more platforms (e.g., servers, computers, electronic machines etc.) and utilize a representational state transfer (REST), SOAP, Extensible Messaging and Presence Protocol (XMPP), a JavaScript API, other similar APIs, or a combination thereof. In certain embodiments, the user contacts a service on the services platform 109 via XMPP and the services platform 109 serves as an intermediary between the UE 101 and the social services platform 103.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, services platform 109, and social services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the social networking application 107 and the social services platform 103 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

Under one scenario, the social API 111 may gather information required to create the profile and store the profile utilizing a distributed key value store 113. Although various embodiments are described with respect to the distributed key value store 113, it is contemplated that the approach described herein may be used with other databases (e.g., a distributed database under the control of a database management system, where the storage devices are not all attached to a common processor or a non-distributed database). The information required to create the profile may include one or more of authentication information (e.g., user name and password), a user identifier, a service associated with the profile, profile data for one or more profile fields, or the like. The social API 111 and/or the distributed key value store 113 may then notify a distributed index engine 115 of the creation of the profile.

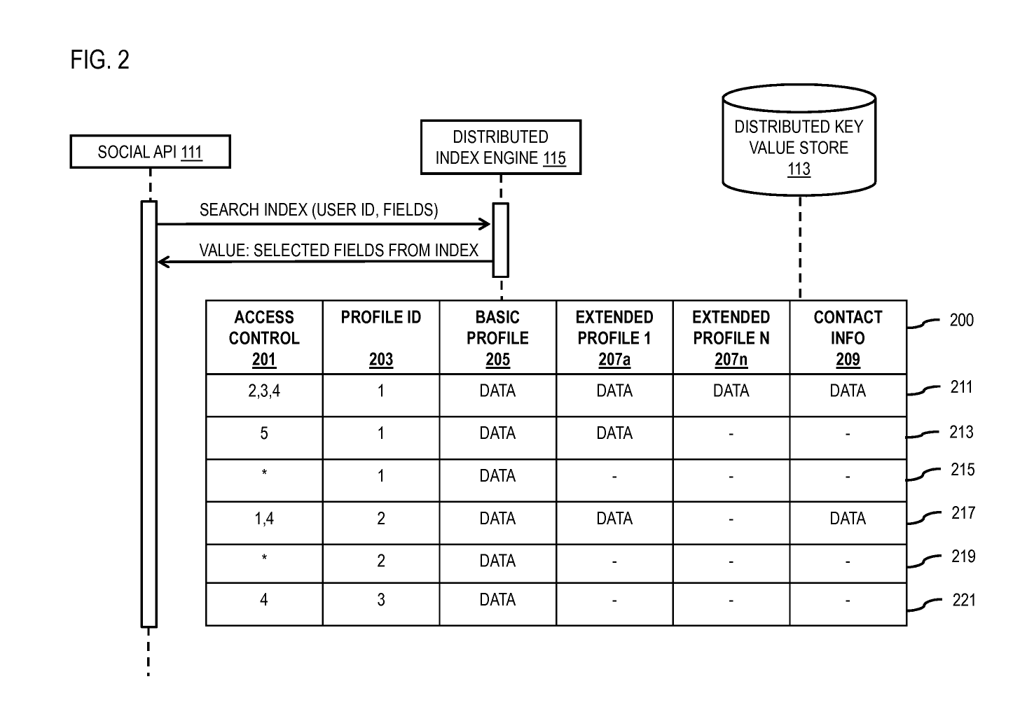

The distributed index engine 115 may add information in the profile to an index of data structures that may be associated with the profile. Once indexed, the profile may be advantageously searched while implementing access control via the data structure. Under certain scenarios, the entire profile is indexed, in other scenarios, only certain portions of the profile are indexed (e.g., text portions). However, the data structures may include place markers for this un-indexed information. As previously noted, the index may be associated with the profile based on parameters set in the profile (e.g., an associated service, a contacts list, an area such as a region or address associated with the profile, etc.). The index may include one or more instances of a data structure. An exemplary index of a data structure that may be utilized by the social services platform 103 is detailed in FIG. 2. Further, the distributed index engine 115 may be utilized to update data fields associated with indexes.

FIG. 1B is a diagram of the components of the distributed index engine 115, according to one embodiment. By way of example, the distributed index engine 115 includes one or more components for providing indexing and searching services to users of the social services platform 103. It is contemplated that the functions of these components may be combined in one or more components or performed by other components of equivalent functionality. In this embodiment, the distributed index engine 115 includes one or more index engines 120a-120n each of which may be utilized to index and/or search and retrieve information based on a query. Each index engine 120 may include an API 121, memory for storing, searching, and utilizing an index of a data structure, an indexing module 125 for generating, searching, and updating indexes, and a storage interface 127 utilized to retrieve information from the distributed key value store 113.

In certain embodiments, the distributed index engine 115 may be implemented utilizing a computing cloud. As such, the distributed index engine 115 may include index engines 120 corresponding to different geographical locations. The index engine 120 may include an API 121 that is used to communicate with e.g., the social API 111, which may interface with clients and services outside of the social services platform 103. Under certain scenarios, the API 121 may directly communicate with clients and services without the use of the social API 111 or the API 121 may include the social API 111.

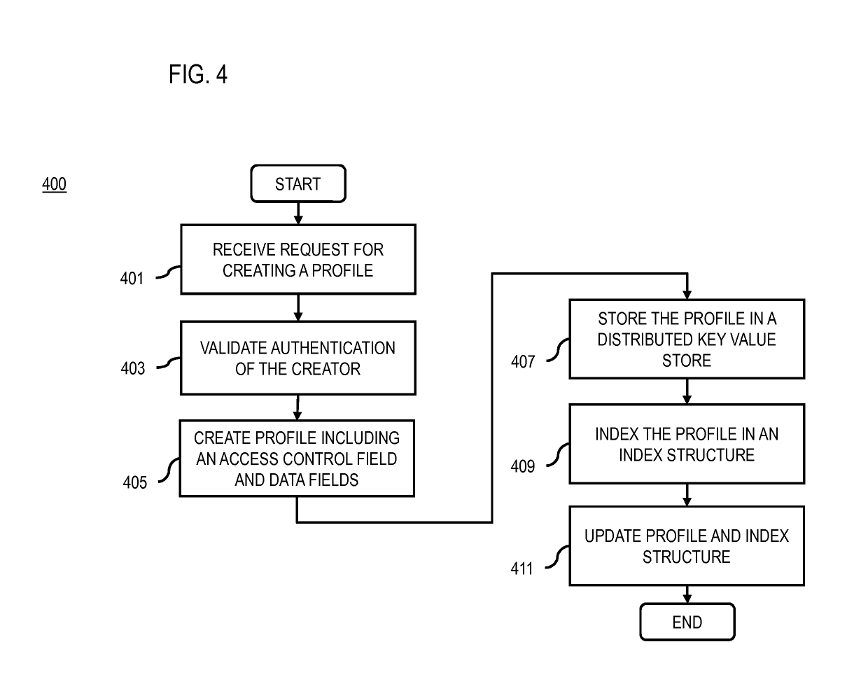

In certain scenarios, the storage interface 127 may interact with the distributed key value store 113 to receive a request for indexing a profile that has been created and stored in the distributed key value store 113. When the index engine 120 receives a request to index a profile, the indexing module 125 of the index engine 120 may instantiate one or more data structures for the profile and add the data structure instances to the associated index in the memory 123 as further detailed in the processes of FIG. 4. As previously mentioned, the data structures may include an access control field and data fields. In certain embodiments, once the data structures are added to the index, the instantiated data structures are communicated to other index engines to update replicated indexes. Because there are more than one indexes, if a particular index engine 120a becomes overloaded or faults, the load may be distributed to other index engines (e.g., index engine 120n).

Further, the storage interface 127 may communicate with the distributed key value store 113 using one or more interfaces. For example, the storage interface 127 may receive data about new profiles for generating an index using a particular profile and retrieve stored information utilizing another interface. For example, to retrieve stored information, the storage interface 127 may use a simple interface that utilizes get, put, delete, and scan commands. Alternatively or additionally, the storage interface 127 may utilize another API to communicate with the distributed key value store 113, which may translate the communications to a simple interface.

FIG. 1C is a diagram of the components of a distributed key value store 113, according to one embodiment. By way of example, the key value store 113 includes one or more components for providing storage of data that can be indexed, stored, retrieved, and searched. Thus, a new profile may be stored in the distributed key value store 113. It is contemplated that the functions of these components may be combined in one or more components or performed by other components of equivalent functionality. It is further contemplated that other forms of databases may be utilized in place of or in addition to the distributed key value store 113. In this embodiment, the distributed key value store 113 includes a client library 141 that may be used to communicate with servers 143, and databases 145a-145n.

The storage interface 127 of the index engines 120a-120n and the social API 111 may communicate with the distributed key value store 113 using a client library 141. In certain embodiments, the index engines 120a-120n and the social API 111 may be considered clients receiving database services from the distributed key value store 113. The client library 141 may include an interface that can determine which servers 143 to communicate with to retrieve content from databases 145. In certain embodiments, databases 145 are stored utilizing a key and value mechanism that allows storage using the key. A portion of each database (e.g., portions A-I) can be linked to a key. In one embodiment, the key is hashed to determine which portion the key is linked to. A key may be hashed using a ring method, for example. Using the ring, each key and portion may be hashed to a primary location (e.g., based on a key with an identifier that is hashed into a number k) as well as one or more backup locations. The backup locations may be locations associated with the next server or host associated with the hash. The client library 141 determines which servers 143 to read and write information from and to using the key hashes. The client library 141 and the servers 143 may each include a lookup table including which portions belong which servers 143.

In certain embodiments, the portion (e.g., portion A 147a-147c) may be stored using multiple servers over multiple databases 145. In one implementation, portions may be replicated over n number (e.g., replicas=3) of servers 143 and databases 145 for redundancy, failover, and to reduce latency. Moreover, the portions may be written to and read from at the same time by the client library 141. When reading from the databases 145, the client library may determine if there are any consistency issues (e.g., portion 147a does not match portion 147b). Moreover, in certain embodiments, an exemplary storage scheme may require that when performing a write or a read, at least a certain number (e.g., required writes=2, required reads=2 etc.) of portions need to be successfully written or read. This allows for redundancy and quorum consistency. If a database 145a fails or is otherwise incapacitated, a portion 147a associated with the database 145a may be later updated with content it should include by servers 143 having replicated portions 147b, 147c.

The social API 111 may request that a new profile be stored in the distributed key value store 113. The new profile may be assigned a key based on an account identifier associated with the new profile. Then, the key may be hashed to determine a portion (e.g., portion A 147) to store the new profile in. Next, the profile is stored in a primary database as well as in backup databases. The profile may be considered a value associated with the key. To retrieve the profile at a later time, the hash of the key may be used to request the profile from the server associated with the portion. Then, the key may be utilized to search the portion for the profile. Once the profile is stored in the distributed key value store 113, the client library 141 may notify an index engine 120 that the profile is to be added to an index.

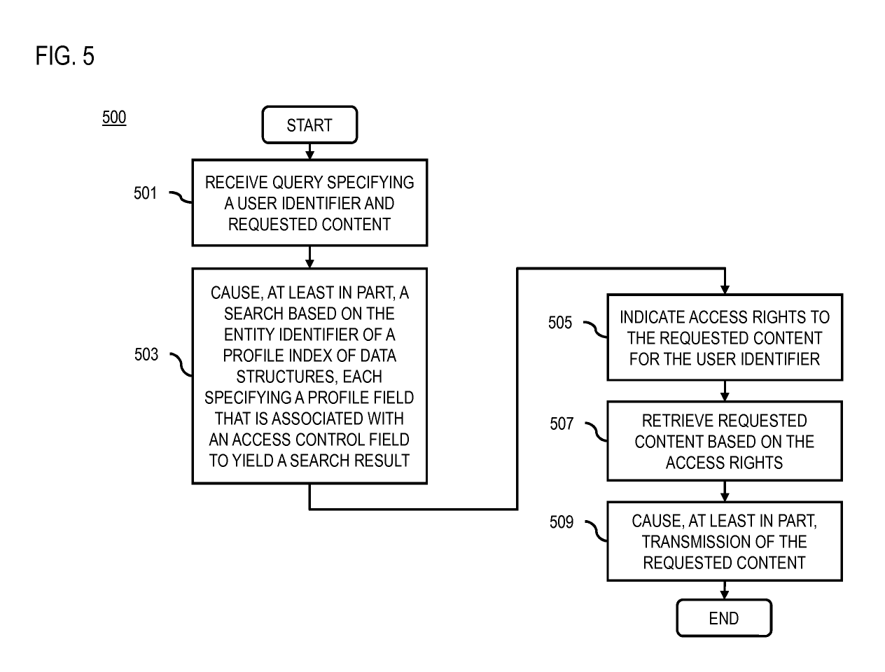

Once an index is created and profiles stored in the distributed key value store 113, the social API 111 may receive a query from a UE 101 or service to cause an index engine 120 to search for and retrieve information based on a user identifier and requested content. The index engine 120 can then retrieve an index associated with the query and search the index for the user identifier in the access control field. The search may be a text based search. Further, the requested content may specify one or more profile identifiers of profiles the query is interested in or a type of content (e.g., basic profile information) the query is interested in. The distributed index engine 115 returns the requested content to the social API 111. The process for retrieving the content is further detailed in the processes of FIGS. 2 and 5.

FIG. 2 is a diagram exemplifying the use of a scalable data structure 200, according to one embodiment. The data structure may include an access control field 201, a profile identifier (ID) 203, data fields such as a basic profile 205, extended profiles 207a-207n, and contact information 209. As previously stated, the access control field may be associated with one or more user identifiers (e.g., user identifiers 1-5, a universal user identifier *, etc.). In certain embodiments, the data structure allows for an entity identifier (e.g., a user identifier) in the access control field 201 to be associated with a profile ID 203 only once. In certain scenarios, the profile ID 203 is a globally unique identifier that can be used to associate content with a user or entity profile. Additionally, the user identifier may be an identifier that associates the query with a particular user, which may or may not have a profile. The access control field may be based on which user or entity identifiers are considered to be contacts or connections such as friends, family, colleagues, acquaintances, one way followers, employees, members, etc. in relation to the user associated with the profile. Users may input these connections via the social networking application 107 and the social API 111.

Multiple levels of access can be provided using the access control field 201. For example, profile ID 1 may allow different content access to different user identifiers based on access control rights. In this example, user identifiers 2, 3, and 4 are allowed access to the basic profile 205, extended profiles 207a and 207n, and contact information 209 of profile ID 1. This access may be provided because of a status of the group (e.g., each are considered friends). However, user identifier 5 may only have access to the basic profile 205 and the first extended profile 207 because user identifier 5 is considered an acquaintance. All users, including guest users, may have access to the basic profile 205 of profile ID 1. The user or entity associated with the profile ID 203 may determine these access controls while creating the profile or by updating the profile. In the case of profile ID 1, the index engine 120 generates three data structures 211, 213, 215 (shown as rows) when adding profile ID 1 to the index. Each of the data structures 211, 213, 215 may include data in the fields marked data. In certain embodiments, this data is searchable. Further, profile ID 2 may have two data structures 217, 219 associated with it, and profile ID 3 may have only one data structure 221 associated with it, each having an access control field that allows access to certain information. Under one scenario, the data structure 221 for profile ID 3 does not include any information that can be provided to guest users, and only access to basic profile data to user identifier 4. Moreover, each data structure (represented by rows) may be indexed using the access control 201 field to determine which entities (e.g., via entity identifiers or user identifiers) have access to the particular data structure row.

Under one scenario, the social API 111 receives a request from a user or service requesting a query to be performed on an index. The social API 111 may authenticate with the user or service to determine a user identifier to be associated with the query. In certain embodiments, the service or user logs in as a guest and receives a guest status. In other embodiments, a user name and password are mapped to the user identifier. The authentication of a user may also be passed through another service. The user or service may also specify in the query content that the user or service wishes to retrieve.

In one embodiment, the user may initiate a search query for all information the user can retrieve. The social API 111 determines that the user identifier for the query is user identifier 4. The query is passed to the distributed index engine 115, which begins the search on the index of the data structure 200. The distributed index engine 115 determines that user identifier 4 has access to the basic profile 205, first extended profile 207a, second extended profile 207n, and contact information 209 of profile ID 1, as well as the basic profile 205, first extended profile 207a, and contact information 209 of profile ID 2, and the basic profile 205 of profile ID 3. This data can then be returned as a value to the social API 111 for transmission to the user. In another scenario, the user identifier for the query is user identifier 5. The distributed index engine 115 returns the information contained in data structures 213 and 219. The distributed index engine 115 may return this data because the user identifier has access to at most, data structure 213 for profile ID 1 and at least guest level access (access granted to all requesters) to profile ID 2, while having no access to profile ID 3. Optionally, the user or service forming the query may request that the query only search through profiles that the user has a higher level access to (e.g., friend access, acquaintance access, colleague access, etc.) rather than simply public access.

In certain scenarios, the requested content may include one or more search terms such as keywords. In these scenarios, the profile ID 203, the basic profile 205, extended profiles 207, and contact information 209 are brief and easily searchable. The distributed index engine 115 may search the content fields 203, 205, 207, 209 for the search terms. Alternatively or additionally, the data associated with the content fields 203, 205, 207, 209 may include pointers (e.g., keys) to the distributed key value store 113 or other unsearchable content. In some embodiments, only profile information that the query has access to are searched. This allows for a low latency in retrieving the profile information. Further, this method allows for a great number of searches and a vast amount of index content to be included in the searches.

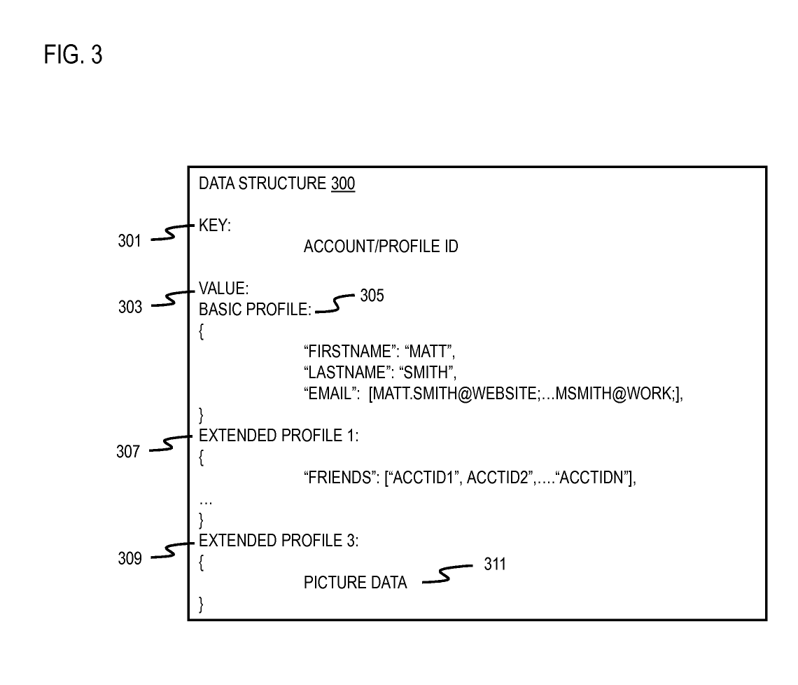

FIG. 3 is a diagram of an exemplary data structure that may be utilized in the distributed key value store, according to one embodiment. Moreover, portions of the data structure 300 may be utilized in the index. The data structure 300 may specify a key 301 that can be associated with a profile ID or account ID. This key 301 can be used to retrieve profiles from the distributed key value store 113. Further, the key 301 is associated with a value 303 that includes the basic profile 305, a first extended profile 307, and other content fields. Moreover, the value may additionally include information that may not be included in the index. For instance, a third extended profile 309 may include picture data 311 that cannot be searched and therefore need not be stored in the index. As such, the third extended profile 309 data in the index may include a flag or other data informing the distributed index engine 115 that the content is available in the distributed key value store 113.

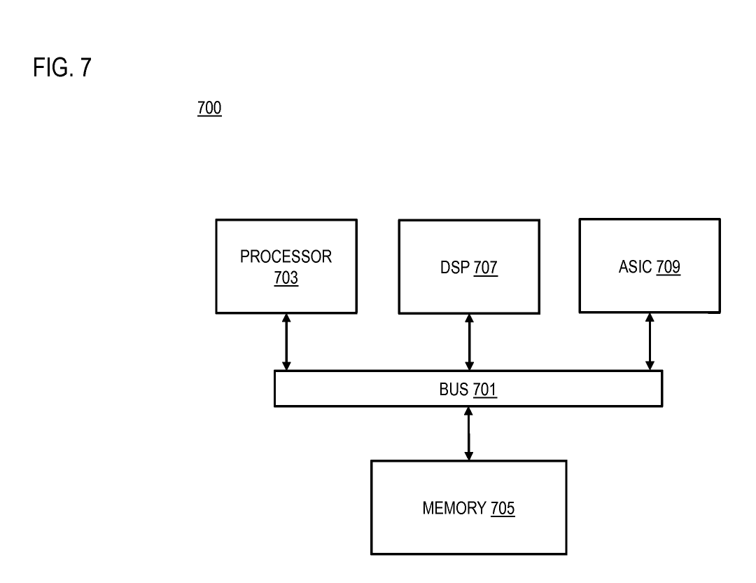

FIG. 4 is a flowchart of a process for creating and indexing a profile, according to one embodiment. In one embodiment, the social API 111 and distributed index engine 115 perform the process 400 and is implemented in, for instance, a chip set including a processor and a memory as shown FIG. 7. As such, the social API 111 and/or distributed index engine 115 may provide means for performing the steps of process 400 and/or other processes described herein. In step 401, the social API 111 receives a request for creating a profile from a client (e.g., a service, a user, an entity, etc.). The social API 111 may then request that the user provide the user's authentication to associate the profile to an account by requesting authentication credentials. Next, the user may send and the social API 111 may receive the credentials and the social API 111 may validate authentication of the user creator of the profile (step 403).

Then, at step 405, the social API may create the profile, which may include an access control field, a user identifier, and other data fields. The social API 111 may query the user for additional information as to what information to store in the profile. The user may input data fields and other customizable data into the profile. Multiple rounds of queries may be needed to complete the profile. Then, at step 407, the social API 111 may store the profile in a distributed key value store 113 as detailed in the description of FIGS. 1B and 1C.

Once the profiles are stored, the social API 111 may cause, at least in part, the distributed index engine 115 to index the profile in an index structure (step 409). The distributed index engine 115 may add the profile to an index. The profile can be associated with the index based on one or more user input, based on associations of the profile (e.g., location, associated services, contact connections, etc.), or based on other data. One or more fields associated with the profile are then indexed based on access control features that may be set by the user. The access control field 201 may be utilized to segregate what information certain users can search and/or retrieve. A new data structure may be instantiated for each segregated group. In certain embodiments, a user is placed in at most one of the instantiated data structures for a given profile (e.g., based on a profile ID 203). Additionally, an instantiated data structure (e.g., data structure 215) may be accessible to the public (e.g., guests, all users, etc.).

Further, at step 411, the profile and index structure can be updated. The user can authenticate and update instead of creating the user's profile as detailed in steps 401 through 407. Once the profile is updated, the distributed index engine 115 may be caused to initiate updating the index based on the changed profile. Changes to the profile may include adding or removing access to certain entities via the access control list, adding or subtracting content, modifying the content available to users in a certain access control field group, adding or subtracting instantiated data structures, combining instantiated data structures, a combination thereof, or the like.

FIG. 5 is a flowchart of a process for utilizing a scalable data structure to search profiles, according to one embodiment. In one embodiment, the distributed index engine 115 performs the process 500 and is implemented in, for instance, a chip set including a processor and a memory as shown FIG. 7. As such, the distributed index engine 115 may be a means for implementing the steps associated with process 500. In step 501, the distributed index engine 115 receives a query specifying an entity identifier and requested content. The user may initiate a keyword search by inputting the requested content and include the user identifier into the search query. As earlier described, the query may be received from a UE 101 or service via a social API 111. The entity identifier (e.g., a user identifier) may specify the user making the request and may be obtained via the social API 111 through an authentication process. The authentication process may include associating a user name and password, token, or other authentication mechanism to the user identifier. The requested content may include one or more field names (e.g., access control 201, profile ID 203, basic profile 205, extended profiles 207a-207n, contact information 209, etc.), or include one or more search terms that may be present in the fields.

Then, at step 503, the distributed index engine 115 causes, at least in part, a search based on the user identifier of a profile index of data structures, each specifying a profile field that is associated with an access control field 201 to yield a search result. As such, the distributed index engine 115 may provide means for implementing step 503. The data structures may further include the profile field (e.g., profile ID 203, basic profile 205, extended profiles 207a-207n, contact information 209, etc.) and the access control field 201. The search may begin by indicating access rights to the requested content for the user identifier (step 505) by comparing the user identifier to the access control field 201 of the index. As such, the distributed index engine 115 provides means for indicating access rights to the requested content for the user identifier. Further, the requested content may include a search term such as a keyword. A textual search for the search term (or more than one term) may be conducted on the profile field of any of the data structures that the user identifier has access to. This textual search may be implemented via developing and storing an inverted index or another index (e.g., a hash or B-tree) for searching for the user based on the access control field. The inverted index access control field may include “words” that are associated with one or more user identifiers, which may include a guest or “*” identifier. As such, the inverted index can quickly find rows of data for which the user identifier has access. Further, this may yield search results that the user both has access to and are part of the textual search. In this manner, the textual search is used to implement access controls as a side effect of the normal search.

Moreover, at step 507, the requested content can be retrieved based on the access rights. As noted previously, the distributed index engine 115 can provide means for implementing step 507. In certain embodiments, the requested content may indicate that information that is not indexed in the profile index is requested. The data structure may provide data (e.g., a flag or a pointer) indicating that there is associated content, but the content is stored in the full profile. As such, the content is retrieved from a distributed key value store 113 using the profile ID 203 of the requested content as a key identifier to generate a request for the profile and causing, at least in part, transmission of the request to the distributed key value store 113. Then, the profile is received and may be forwarded. In other embodiments, the requested content may be one or more of the profile fields, which may be retrieved directly from the index. In certain scenarios, the requested content may be the data structure 300 from the index or from the profile. Then, as in step 509, the requested content is caused, at least in part, to be transmitted to the requestor via the social API 111.

The above approaches and examples detail the use of a data structure that is advantageously scalable. The data structure is may additionally offer low latency searches utilizing the above indexing approach. This may be implemented via storing an access control field in conjunction with text searchable profile fields in the index of the data structure. Further, the indexes may be extended to include larger data content by quickly retrieving the content from a distributed data store (e.g., store 113 of FIG. 1) using just a unique profile ID associated with the data structure. Moreover, because the data structure may be used in a distributed architecture, the availability of the use of the information stored using the data structure is highly available. This functionality may be implemented because a large number of portions including data are spread across a number of physical machines.

The processes described herein for utilizing a scalable data structure may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

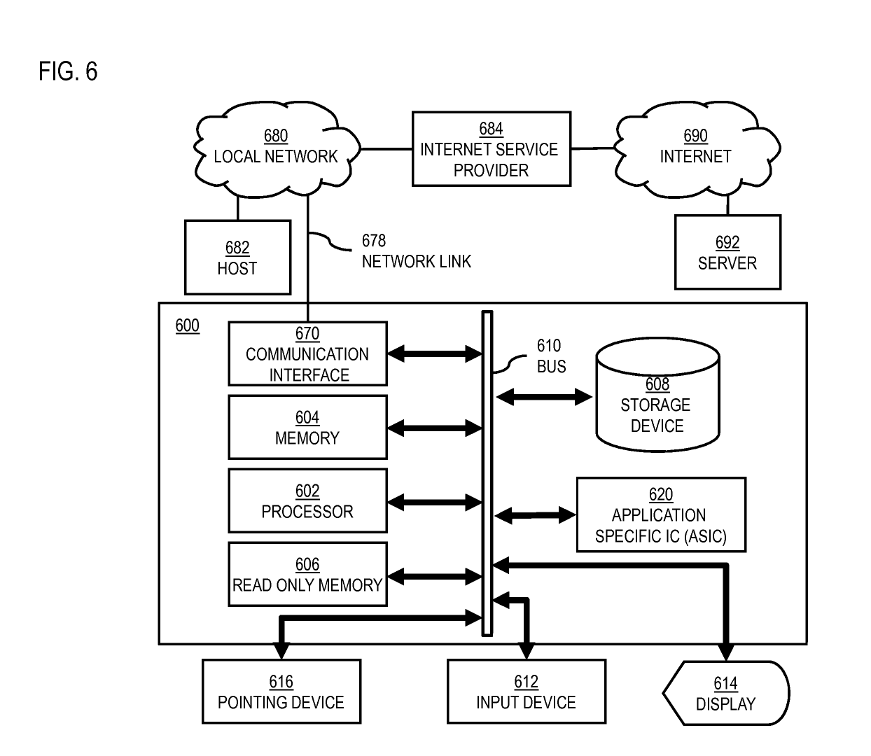

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to utilize a scalable data structure as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of utilizing a scalable data structure.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to utilizing a scalable data structure. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for utilizing a scalable data structure. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for utilizing a scalable data structure, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to utilize a scalable data structure as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of utilizing a scalable data structure.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to utilize a scalable data structure. The memory 705 also stores the data associated with or generated by the execution of the inventive steps.

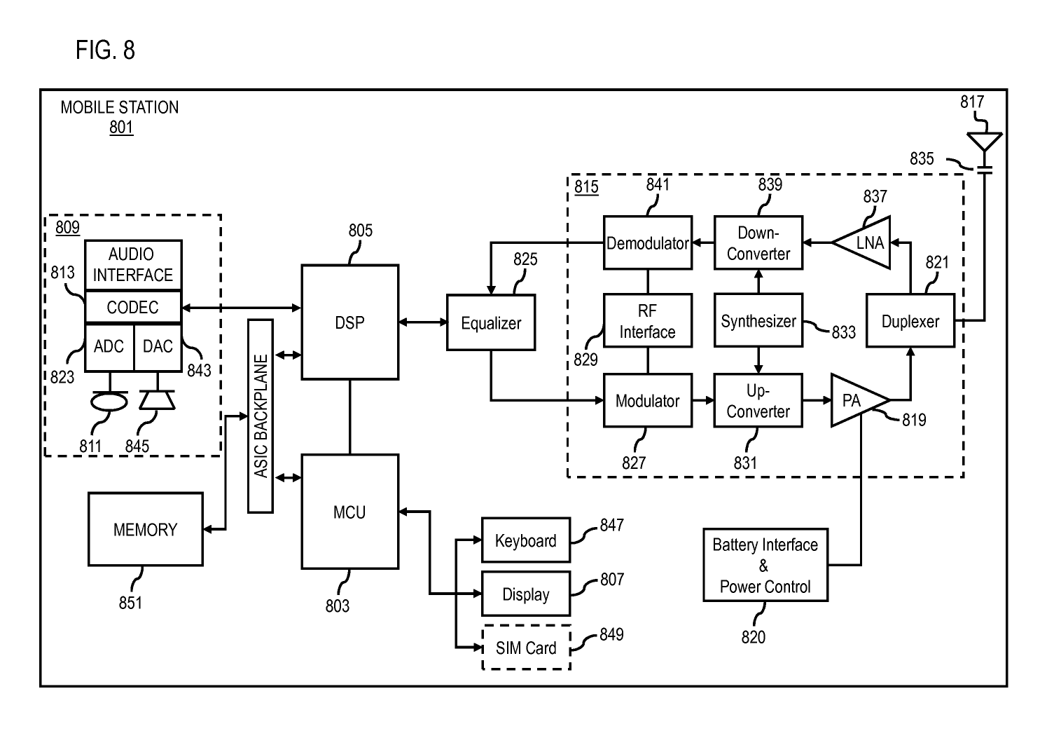

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of requesting content from a platform utilizing a scalable data structure. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of requesting content from a platform utilizing a scalable data structure. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to request content from a platform utilizing a scalable data structure. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a query specifying an entity identifier and requested content;
causing, at least in part, a search based on the entity identifier of a profile index of data structures, each specifying a profile field that is associated with an access control field to yield a search result; and
indicating access rights to the requested content for the entity identifier,
wherein the data structures further include the profile field and the access control field.

2. A method of claim 1, further comprising:
retrieving the requested content based on the access rights, wherein the search yields only the search results that are indicated to have access.

3. A method of claim 1, wherein the profile index is searched based on a comparison of the entity identifier and the access control field.

4. A method of claim 1, wherein the access control field includes a plurality of entity identifiers.

5. A method of claim 4, wherein the profile field is a basic profile field and the data structure further includes an extended profile field, and wherein the access control field is utilized to specify access rights to the basic profile field and the extended profile field.

6. A method of claim 1, wherein the requested content includes a keyword and the search includes a textual search of the profile fields based on the keyword, the method further comprising:
causing, at least in part, transmission of the search result.

7. A method of claim 1, wherein the profile field is further associated with a profile identifier that corresponds to one or more of the data structures, and the profile index is searched based on a comparison of the entity identifier and the access control field, the profile identifier being only associated with the entity identifier in one of the data structures.

8. An apparatus comprising:
at least one processor; and
at least one memory including computer program code,
the at least one memory and the computer program code configured to, with the at least one processor, cause the apparatus to perform at least the following,
receive a query specifying an entity identifier and requested content;
cause, at least in part, a search based on the entity identifier of a profile index of data structures, each specifying a profile field that is associated with an access control field to yield a search result; and
indicate access rights to the requested content for the entity identifier,
wherein the data structures further include the profile field and the access control field.

9. An apparatus of claim 8, wherein the apparatus is further caused, at least in part, to:
retrieve the requested content based on the access rights, wherein the search yields only the search results that are indicated to have access.

10. An apparatus of claim 8, wherein the profile index is searched based on a comparison of the entity identifier and the access control field.

11. An apparatus of claim 8, wherein the access control field includes a plurality of entity identifiers.

12. An apparatus of claim 11, wherein the profile field is a basic profile field and the data structure further includes an extended profile field, and wherein the access control field is utilized to specify access rights to the basic profile field and the extended profile field.

13. An apparatus of claim 11, wherein the requested content includes a keyword, the search includes a textual search of the profile fields based on the keyword, and the apparatus is further caused, at least in part, to:
cause, at least in part, transmission of the search result.

14. An apparatus of claim 11, wherein the profile field is further associated with a profile identifier that corresponds to one or more of the data structures, and the profile index is searched based on a comparison of the entity identifier and the access control field, the profile identifier being only associated with the entity identifier in one of the data structures.

15. A computer-readable storage medium carrying one or more sequences of one or more instructions which, when executed by one or more processors, cause an apparatus to at least perform the following steps:
receiving a query specifying an entity identifier and requested content;
causing, at least in part, a search based on the entity identifier of a profile index of data structures, each specifying a profile field that is associated with an access control field to yield a search result; and
indicating access rights to the requested content for the entity identifier,
wherein the data structures further include the profile field and the access control field.

16. A computer-readable storage medium of claim 15, wherein the apparatus is caused, at least in part, to further perform:
retrieving the requested content based on the access rights, wherein the search yields only the search results that are indicated to have access.

17. A computer-readable storage medium of claim 15, wherein the profile index is searched based on a comparison of the entity identifier and the access control field.

18. A computer-readable storage medium of claim 15, wherein the access control field includes a plurality of entity identifiers.

19. A computer-readable storage medium of claim 18, wherein the profile field is a basic profile field and the data structure further includes an extended profile field, and wherein the access control field is utilized to specify access rights to the basic profile field and the extended profile field.

20. A computer-readable storage medium of claim 15, wherein the requested content includes a keyword, the search includes a textual search of the profile fields based on the keyword, and wherein the apparatus is caused, at least in part, to further perform:
causing, at least in part, transmission of the search result.
